(19) United States
(12) Patent Application Publication
(10) Pub. No.: US 2023/0253679 A1
(43) Pub. Date: Aug. 10, 2023

(54) OVERMOLDED INTERCONNECT BOARD ASSEMBLY FOR POWER MODULE

(71) Applicant: GM GLOBAL TECHNOLOGY OPERATIONS LLC, Detroit, MI (US)

(72) Inventors: Mitchell Stojanovski, Birmingham, MI (US); Nicholas Compton, Troy, MI (US); Annabella Wong, Clawson, MI (US)

(73) Assignee: GM GLOBAL TECHNOLOGY OPERATIONS LLC, Detroit, MI (US)

(21) Appl. No.: 17/665,714

(22) Filed: Feb. 7, 2022

(51) Int. Cl. H01M 50/502; H01M 50/204; H01M 50/543

(52) U.S. Cl. CPC H01M 50/502; H01M 50/204; H01M 50/543

(57) ABSTRACT

An interconnect board assembly includes a busbar assembly with at least one track having a plurality of busbars. The interconnect board assembly may be used with a power module having a plurality of battery cells. The interconnect board assembly includes a senseline assembly having a plurality of traces extending in proximity to the at least one track. An overmolded board frame is integrally formed over the busbar assembly and the senseline assembly. The overmolded board frame defines a first surface and a second surface. The overmolded board frame is configured such that a rigid load path is completed when the busbar assembly is joined to the senseline assembly and the plurality of battery cells.

### INTRODUCTION

The present disclosure relates to an overmolded interconnect board assembly employable in a power module and a corresponding method of assembly. Power modules for generating usable energy have numerous applications in a wide variety of settings. The use of purely electric vehicles and hybrid vehicles has greatly increased over the last few years. Electric-powered transportation devices may utilize power modules, such as battery modules, to energize a motor/generator. Additionally, power modules may be employed in power conversion equipment such as, but not limited to, industrial motor drives, embedded motor drives and AC-DC power supplies.

### SUMMARY

Disclosed herein is an interconnect board assembly usable with a power module having a plurality of battery cells. The interconnect board assembly includes a busbar assembly with at least one track having a plurality of busbars. The interconnect board assembly includes a senseline assembly having a plurality of traces extending in proximity to the at least one track. An overmolded board frame is integrally formed over the busbar assembly and the senseline assembly. The overmolded board frame is configured such that a rigid load path is completed when the busbar assembly is joined to the senseline assembly and the plurality of battery cells.

The busbar assembly defines a first edge and a second edge. A first terminal and a second terminal may be electrically connected to the at least one track at the first edge, with one of the first terminal and the second terminal being positive and the other being negative. An end connector may be electrically connected to the at least one track at the second edge. In some embodiments, at least one pad is connected to the plurality of traces at the second edge.

The overmolded board frame defines a first surface and a second surface. The first surface of the overmolded board frame may include a plurality of spaced-apart pockets adapted as a structural locating feature for the busbar assembly. A fuse may be connected to a portion of the senseline assembly and aligned with at least one of the plurality of spaced-apart pockets. In some embodiments, the overmolded board frame is bonded to the plurality of battery cells at the second surface. The second surface may include a plurality of spaced-apart indentations adapted to locate and retain the plurality of battery cells.

The plurality of busbars may each define respective opposing sides having respective tabs extending therefrom and the plurality of busbars is aligned with the overmolded board frame such that the respective tabs of neighboring ones of the plurality of busbars are positioned in the plurality of spaced-apart pockets. The respective tabs of neighboring ones of the plurality of busbars may be welded through the plurality of spaced-apart pockets. The respective tabs may be substantially orthogonal to the plurality of busbars. At least one of the plurality of busbars may include a first conductor layer and a second conductor layer welded to the first conductor layer. The first conductor layer is directly connected to at least one of the plurality of battery cells, and the second conductor layer extends between the first conductor layer and the senseline assembly.

Disclosed herein is a method of assembling a power module having a plurality of battery cells and an interconnect board assembly. The method includes obtaining a busbar assembly having at least one track with a plurality of busbars. The method includes obtaining a senseline assembly with a plurality of traces extending in proximity to the at least one track and forming an overmolded board frame over the busbar assembly and the senseline assembly, via a molding apparatus. The overmolded board frame defines a first surface and a second surface. The overmolded board frame is configured such that a rigid load path is completed when the busbar assembly is joined to the senseline assembly and the plurality of battery cells.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary exploded view of an interconnect board assembly;

FIG. 2 is a schematic fragmentary perspective view of the interconnect board assembly after molding;

FIG. 3 is a schematic fragmentary sectional view of the interconnect board assembly taken through axis 3-3 in FIG. 2;

FIG. 4 is a schematic fragmentary top view of another example interconnect board assembly;

FIG. 5 is a schematic sectional view of a portion of the interconnect board assembly of FIG. 4, illustrating a fuse; and

FIG. 6 is a flowchart of an example method of assembling a power module incorporating the interconnect board assembly of FIGS. 1-5.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

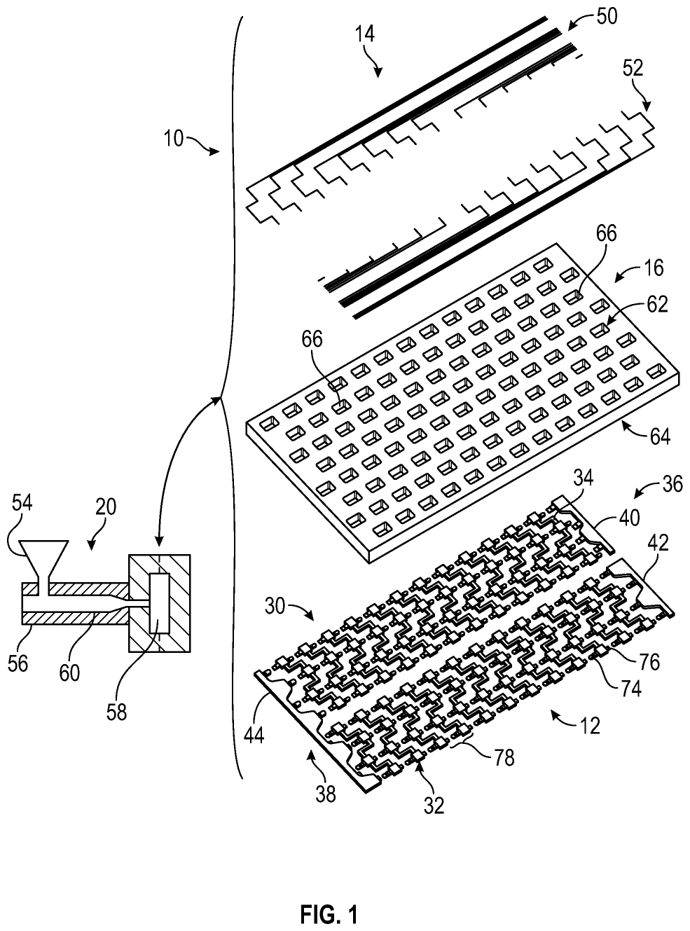

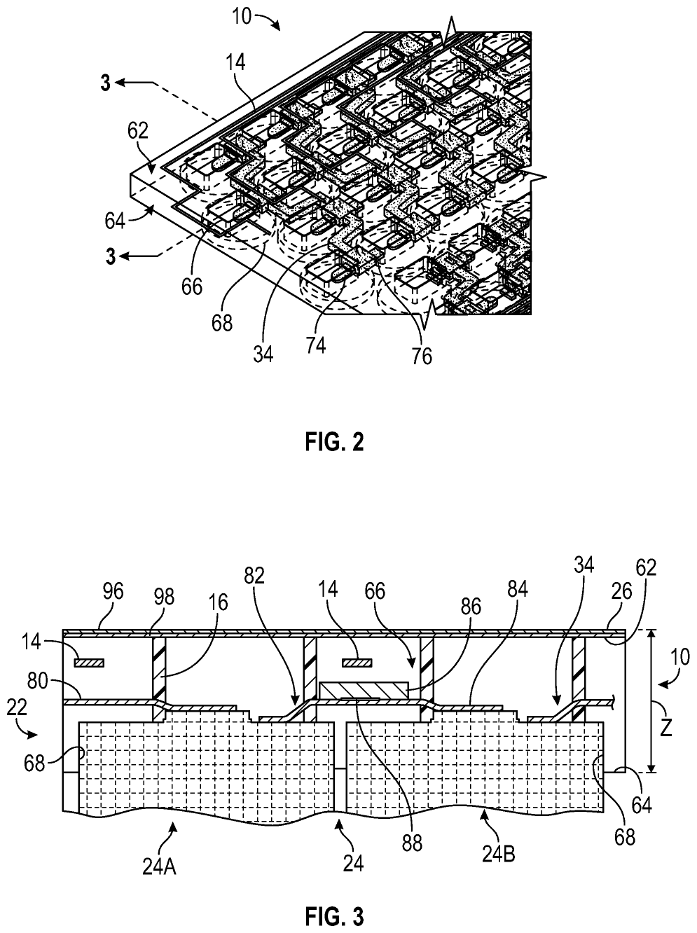

Referring to the drawings, wherein like reference numbers refer to like components, FIGS. 1-5 illustrate various configurations of an interconnect board assembly. FIG. 1 is a schematic fragmentary exploded view of an interconnect board assembly 10. The interconnect board assembly 10 includes a busbar assembly 12 and a senseline assembly 14. As described below, an overmolded board frame 16 is integrally formed, via a molding apparatus 20, over the busbar assembly 12 and the senseline assembly 14. FIG. 2 shows the interconnect board assembly 10 after the molding process.

Interconnect board assemblies are generally manufactured as two or more separate sub-assemblies. The interconnect board assembly 10 presented herein combines multiple components into one assembly. By combining these sub-assemblies into one component, the need for fastening and locating between them is removed. The interconnect board assembly 10 simultaneously functions as a structural, cell holding, sensing (including fusing) and bussing solution. FIG. 3 shows a sectional view through a portion of the interconnect board assembly 10, taken through axis 3-3 in FIG. 2.

The interconnect board assembly 10 also reduces space taken up by sensing (reducing the height Z of the interconnect board assembly 10 shown in FIG. 3) o and bussing within the limited allotted space (e.g., in a vehicle) while providing a robust solution. Referring to FIG. 3, the interconnect board assembly 10 may be used with a power module 22 having a plurality of battery cells 24 (“plurality of” omitted henceforth), such as first cell 24A and second cell 24B, shown in FIG. 3. The battery cells 24 may be cylindrical or pouch-type cells, including but not limited to, lithium manganese, lithium-ion phosphate, lithium cobalt, lithium-nickel based cells. It is to be understood that the power module 22 may take many different forms and include multiple and/or alternate components.

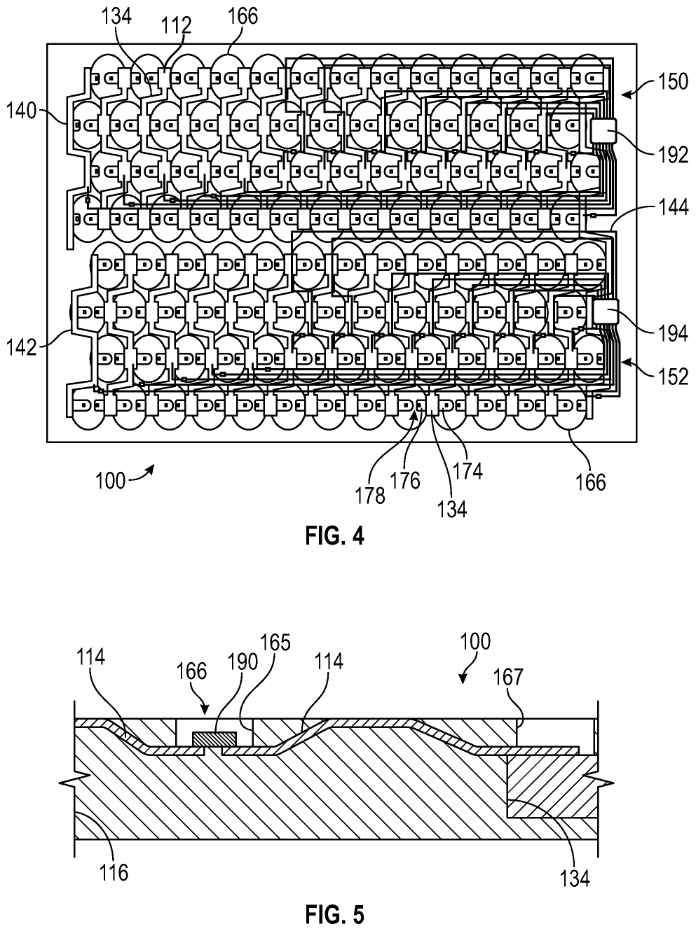

Referring to FIG. 3, the overmolded board frame 16 is configured such that a rigid load path, between the battery cells 24 and a battery pack structure 26, is completed when the busbar assembly 12 is joined to the senseline assembly 14 and the battery cells 24. The design enables the interconnect board assembly 10 to become a structural component within the battery pack structure 26. FIG. 4 shows another example interconnect board assembly 100, to be described below. FIG. 5 shows a schematic sectional view through a portion of the interconnect board assembly 100.

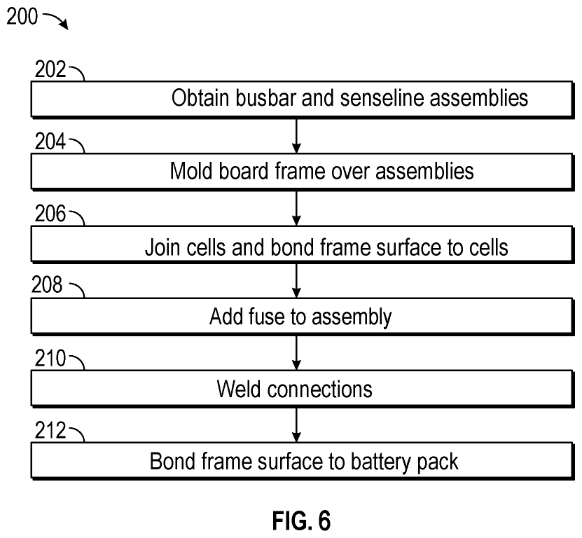

Referring now to FIG. 6, an example flowchart of a method 200 of assembling the power module 22 is shown. Method 200 need not be applied in the specific order recited herein and may be dynamically executed.

Per block 202 of FIG. 6, the method 200 includes obtaining the busbar assembly 12 and the senseline assembly 14. Referring to FIGS. 1-3, the busbar assembly 12 includes at least one track having a plurality of busbars 34 (“plurality of” omitted henceforth). In the embodiment shown, the busbar assembly 12 includes a first track 30 and a second track 32. It is understood that the number and placement of the tracks may be varied based on the application. The busbar assembly 12 provides the connection through which an electrical load draws battery power. The busbars 34 are conductive and may include, for example, alternating copper and aluminum busbars in a possible embodiment, or busbars constructed of the same material, e.g., aluminum, copper, bimetal, or a combination thereof. The busbars 34 are placed in conductive contact with (e.g., via welding) the electrode terminals of individual ones of the battery cells 24 to complete an electrical circuit. The number of busbars 34 is dependent upon the particular construction and use of the power module 22, e.g., the number of battery cells/cell groups used in the power module 22, whether the connections of such cells/cell groups are series or parallel etc. The busbars 34 may be constructed of strip metal that is stamped and/or machined or another suitable fabrication process. The first and second tracks 30, 32 are substantially parallel to one another and extend in a first direction D1. The busbars 34 are substantially parallel to one another and extend in a second direction D2, which may be orthogonal to the first direction D1.

Referring to FIG. 1, the busbar assembly 12 defines a first edge 36 and a second edge 38. A first terminal 40 and a second terminal 42 are electrically connected to the first track 30 and the second track 32, respectively, both at the first edge 36 as shown in FIG. 1. Referring to FIG. 1, an end connector 44 (e.g., a U-flow collector where the current makes a U-turn) is electrically connected to the first track 30 and the second track 32 at the second edge 38. FIG. 4 shows a first terminal 140, a second terminal 142 and a U-flow connector 144 electrically connected to the busbar assembly 112. One of the first terminal 40 (or 140) and the second terminal 42 (or 142) is positive and the other is negative.

Referring to FIGS. 1 and 2, the senseline assembly 14 provides cell voltage sensing (relative to the battery cells 24), giving feedback for a power supply to adjust based on the difference between its intended output and its actual output. The senseline assembly 14 may further provide temperature sensing to determine temperature variation or possible thermal runway events. The senseline assembly 14 includes a plurality of traces, such as a first set of traces 50 and a second set of traces 52 positioned adjacent or in proximity to the first track 30 and the second track 32, respectively.

In the embodiment shown in FIG. 1, the first set of traces 50 and the second set of traces 52 are substantially parallel to one another and extend in the first direction D1. The thickness and length of the components in the senseline assembly 14 may vary depending on materials used for the application and may be adjusted according to the amount of current required to pass through. The senseline assembly 14 may be formed using software-based processes such as photoimaging, laser drilling, printing, cutting or contouring. Alternately, the processes may include stamped lead frames, inserts or injection molds. Surface treatments may be applied, including but not limited to, nickel plating, additive copper surface treatments, and combinations of copper underplate, nickel plating and tin plating.

Proceeding to block 204 of FIG. 6, the overmolded board frame 16 is integrally formed over the busbar assembly 12 and the senseline assembly 14, via a molding process. The term “overmolded’ is intended to convey structure in addition to describing a process of forming. An example molding apparatus 20 is shown in FIG. 1. By way of example, a polymeric material may be inserted through a feeder 54 (see FIG. 1) and heated with a heating element 56. Referring to FIG. 1, a mold cavity 58 receives the molten polymeric material through an injector 60. The busbar assembly 12 and the senseline assembly 14 are placed into the mold cavity 58. The board frame 16 is molded directly over the busbar assembly 12 and the senseline assembly 14 to create a single solid piece, which hardens to its final shape and is subsequently released. The inner shape of the mold cavity 58 may be varied based on the application at hand. It is understood that the molding apparatus 20 may have a different configuration and include other components not shown.

The overmolded board frame allows for an embedded senseline fusing strategy. In a wireless embodiment, for example, the overmolded board frame 16 may be molded over a radio frequency (RF) communications chip (not shown). Additionally, because the features are molded directly over the component the need for secondary isolation components (such as finger-proofing at terminals) is eliminated. Referring to FIGS. 1-3, the overmolded board frame 16 defines a first surface 62 and a second surface 64. The first surface 62 of the overmolded board frame 16 is molded to include a plurality of spaced-apart pockets 66 (shown in FIGS. 1-3) as a structural locating feature for the busbar assembly 12. FIG. 4 shows a plurality of spaced-apart pockets 66 in accordance with another embodiment. While the pockets 66 (shown in FIGS. 1-3) are rectangular in shape, the pockets 166 (shown in FIG. 4) are oval. It is understood that the shape of the pockets 66, 166 may be varied based on the application at hand.

The polymeric material may include performance plastics, polymers, synthetic resins or other materials. In some embodiments, the polymeric materials may be reinforced with a second material, such as glass fiber, carbon fiber or resin. The polymeric materials may include polyamides, such as Polyphthalamide Polyarylamide (PAA), Poly[imino(1,6-dioxohexamethylene) iminohexamethylene], and poly(hexano-6-lactam). Other suitable polymeric materials may include acrylonitrile butadiene styrene, polymethyl methacrylate, one or more cycloolefin copolymers, one or more liquid crystal polymers, polyoxymethylene, one or more polyacrylates, polyacrylonitrile, one or more polyamide-imides, one or more polyaryletherketones (e.g., polyetheretherketone, polyetherketoneketone), polybutadiene, polybutylene, polybutylene terephthalate, one or more chlorofluoropolymers (e.g., polychlorotrifluoroethylene), polyethylene terephthalate, polycyclohexylene dimethylene terephthalate, one or more polycarbonates, one or more polyhydroxyalkanoates, one or more polyketones, polyetherimide, one or more polysulfones, one or more polyimides, polyphenylene oxide, polyphenylene sulfide, polypropylene, polyethylene, and combinations or blends thereof.

Proceeding to block 206 of FIG. 6, the method 200 includes joining the battery cells 24 and bonding the second surface 64 of the overmolded board frame 16 to the battery cells 24. Referring to FIG. 2, the second surface 64 of the overmolded board frame 16 is molded to include a plurality of spaced-apart indentations 68 for locating and retaining the plurality of battery cells 24. In other word, each of the indentations is sized to fit an individual one of the battery cells 24.

Advancing to block 208 of FIG. 6, the method 200 may include connecting a fuse to prevent a circuit overload, such as fuse 190 to the interconnect board assembly 100 shown in FIG. 5. Referring to FIG. 5, a senseline assembly 114 and a busbar 134 are embedded within an overmolded board frame 116. The fuse 190 is positioned in one of the spaced-apart pockets 166 (e.g., first pocket 165) and conductively joined to a portion of the senseline assembly 114. A second pocket 167 is also shown in FIG. 5. The total number of fuses may be varied based on the application at hand.

Proceeding to block 210 of FIG. 6, the method 200 includes welding various connection points, such as between respective portions of the senseline assembly 14 to the busbar assembly 12. The welding operatively connects the senseline assembly 14 and the busbar assembly, allowing for sensing cell voltage in conjunction with a battery management system. The welding may be done ultrasonically. Resistance welding and laser welding may be employed alternatively or in addition to ultrasonic welding.

Referring to FIGS. 1 and 2, each of the busbars 34 have respective tabs 74, 76 extending from two respective opposing sides. In some embodiments, the respective tabs 74, 76 are substantially orthogonal to the busbars 34. Referring to FIG. 2, the busbars 34 are aligned with the overmolded board frame 16 such that the respective adjacent tabs 78 of neighboring ones of the busbars 34 are positioned in the plurality of spaced-apart pockets 66. FIG. 4 shows busbars 134 with respective tabs 174, 176 extending from two respective opposing sides. The respective adjacent tabs 78 in FIG. 2 (and respective adjacent tabs 178 in FIG. 4) are welded together through access provided by the plurality of spaced-apart pockets 66 (pockets 166 in FIG. 4). The battery cells 24 are welded to connecting joints in the busbar assembly 12.

Referring to FIG. 3, the busbars 34 may include a one-piece configuration having a single conductor layer 80 that is directly connected to at least one of the battery cells (e.g., first cell 24A), or a two-piece configuration 82 or a combination of both. Referring to FIG. 3, the two-piece configuration 82 includes a first conductor layer 84 that is directly connected to at least one of the battery cells (e.g., second cell 24B), and a second conductor layer 86 connected to the first conductor layer 84 via a weld 88. Various weld strategies, such as laser welding, ultrasonic welding, resistance welding, wire/ribbon bonding, may be employed. The second conductor layer 86 extends between the first conductor layer 84 and the senseline assembly 14.

Block 210 may further include, referring to FIG. 4, electrically connecting at least one pad to the plurality of traces, e.g., a first pad 192 and a second pad 194 connected respectively to the first set of traces 150 and the second set of traces 152. The first and second pads 192, 194 may be formed by etching metal foil (such as aluminum or copper), plating metal and printing of conductive inks. The size, shape and location of the first and second pads 192, 194 may be varied based on the particular application, including how much space is available and the number of trace sets. Alternatively, depending on the design, a connector may be employed. The remaining ends of the first and second set of traces 50, 52 may be terminated, for example, by crimping, soldering, welding, electrically conductive adhesive bonding and other methods.

Proceeding to block 212 of FIG. 6, the method 200 further includes bonding the first surface 62 of the overmolded board frame 16 to the battery pack 26. As shown in FIG. 3, the first surface 62 may be connected to the battery pack 26, for example, through an intermediate layer 96 (which may be conductive) and an adhesive layer 98. As noted above, some steps may be omitted, and the order of steps changed. The interconnect board assembly 10 may further include other electronic components in the form of cell monitoring chips, sensors, capacitors, resistors, transceivers, heat sinks, etc. The interconnect board assembly 10 may communicate with a battery controller (not shown) over a wireless/radio frequency (RF) link and/or by transmitting signals over a hardwired set of transfer conductors.

In summary, interconnect board assembly 10 provides a rigid load path when the busbar assembly 12 is joined to the senseline assembly 14 and the plurality of battery cells 24. The structural integration described herein enables a one-step vertical installation with robust positioning of battery cells, busbars (current collectors), senselines and weld locations. The structural integration allows for battery pack mass reductions and simplifies assembly complexity. Another technical advantage is that the interconnect board assembly 10 eliminates the need for a flexible circuit board. However, it is understood that flexible circuit boards may be utilized in conjunction with the above structure.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or more desired characteristics from other embodiments, resulting in other embodiments not described in words or by reference to the drawings. Accordingly, such other embodiments fall within the framework of the scope of the appended claims.

What is claimed is:

1. An interconnect board assembly for use with a power module having a plurality of battery cells, comprising:
a busbar assembly including at least one track having a plurality of busbars;
a senseline assembly including a plurality of traces extending in proximity to the at least one track;
an overmolded board frame integrally formed over the busbar assembly and the senseline assembly, the overmolded board frame defining a first surface and a second surface; and
wherein the overmolded board frame is configured such that a rigid load path is completed when the busbar assembly is joined to the senseline assembly and the plurality of battery cells.

2. The interconnect board assembly of claim 1, wherein the busbar assembly defines a first edge and a second edge, further comprising:
a first terminal and a second terminal electrically connected to the at least one track at the first edge, one of the first terminal and the second terminal being positive and another being negative; and
an end connector electrically connected to the at least one track at the second edge.

3. The interconnect board assembly of claim 2, further comprising:
at least one pad connected to the plurality of traces at the second edge.

4. The interconnect board assembly of claim 1, wherein the first surface of the overmolded board frame includes a plurality of spaced-apart pockets adapted as a structural locating feature for the busbar assembly.

5. The interconnect board assembly of claim 4, further comprising:
a fuse connected to a portion of the senseline assembly and aligned with at least one of the plurality of spaced-apart pockets.

6. The interconnect board assembly of claim 4, wherein the plurality of busbars each define respective opposing sides having respective tabs extending therefrom and the plurality of busbars is aligned with the overmolded board frame such that the respective tabs of neighboring ones of the plurality of busbars are positioned in the plurality of spaced-apart pockets.

7. The interconnect board assembly of claim 6, wherein the respective tabs of neighboring ones of the plurality of busbars are welded through the plurality of spaced-apart pockets.

8. The interconnect board assembly of claim 6, wherein the respective tabs are substantially orthogonal to the plurality of busbars.

9. The interconnect board assembly of claim 1, wherein the overmolded board frame is bonded to the plurality of battery cells at the second surface and the second surface includes a plurality of spaced-apart indentations adapted to locate and retain the plurality of battery cells.

10. The interconnect board assembly of claim 1, wherein at least one of the plurality of busbars includes a first conductor layer and a second conductor layer welded to the first conductor layer, the first conductor layer being directly connected to at least one of the plurality of battery cells, and the second conductor layer extending between the first conductor layer and the senseline assembly.

11. A method of assembling a power module having a plurality of battery cells and an interconnect board assembly, the method comprising:
obtaining a busbar assembly having at least one track with a plurality of busbars;
obtaining a senseline assembly with a plurality of traces extending in proximity to the at least one track;
forming an overmolded board frame over the busbar assembly and the senseline assembly, via a molding apparatus, the overmolded board frame defining a first surface and a second surface; and
configuring the overmolded board frame such that a rigid load path is completed when the busbar assembly is joined to the senseline assembly and the plurality of battery cells.

12. The method of claim 11, wherein the overmolded board frame defines a first edge and a second edge, and further comprising:
electrically connecting a first terminal and a second terminal to the at least one track at the first edge; and
electrically connecting an end connector to the first track and the second track at the second edge.

13. The method of claim 12, further comprising:
electrically connecting at least one pad to the plurality of traces at the second edge.

14. The method of claim 11, further comprising:
molding the first surface of the overmolded board frame to include a plurality of spaced-apart pockets as a structural locating feature for the busbar assembly.

15. The method of claim 14, further comprising:
connecting a fuse to a portion of the senseline assembly and aligning the fuse with at least one of the plurality of spaced-apart pockets.

16. The method of claim 14, further comprising:
configuring the plurality of busbars with two respective opposing sides each having respective tabs extending therefrom; and
aligning the plurality of busbars with the overmolded board frame such that the respective tabs of neighboring ones of the plurality of busbars are positioned in the plurality of spaced-apart pockets.

17. The method of claim 16, further comprising:
welding together the respective tabs of neighboring ones of the plurality of busbars through the plurality of spaced-apart pockets, the respective tabs being substantially orthogonal to the plurality of busbars.

18. The method of claim 11, further comprising:
molding the second surface of the overmolded board frame to include a plurality of spaced-apart indentations for locating and retaining the plurality of battery cells.

19. The method of claim 11, further comprising:
configuring at least one of the plurality of busbars to include a first conductor layer and directly connecting the first conductor layer to at least one of the plurality of battery cells; and
welding a second conductor layer to the first conductor layer, the second conductor layer extending between the first conductor layer and the senseline assembly.

20. A method of assembling a power module having a plurality of battery cells and an interconnect board assembly, the method comprising:
obtaining a busbar assembly with a first track and a second track each respectively having a plurality of busbars;
obtaining a senseline assembly with a first plurality of traces and a second plurality of traces, the senseline assembly being positioned such that the first plurality of traces and the second plurality of traces extend adjacent to the first track and the second track, respectively;
forming an overmolded board frame over the busbar assembly and the senseline assembly, via a molding apparatus, the overmolded board frame defining a first surface and a second surface;
molding the first surface of the overmolded board frame to include a plurality of spaced-apart pockets as a structural locating feature for the busbar assembly;
molding the second surface of the overmolded board frame to include a plurality of spaced-apart indentations for locating and retaining the plurality of battery cells; and
configuring the overmolded board frame such that a rigid load path is completed when the busbar assembly is joined to the senseline assembly and the plurality of battery cells.
